(19) United States
(12) Patent Application Publication
(10) Pub. No.: US 2011/0201365 A1
(43) Pub. Date: Aug. 18, 2011

(54) M2M GROUP BASED ADDRESSING USING CELL BROADCAST SERVICE

(75) Inventor: Louis SEGURA, Saint Laurent (CA)

(73) Assignee: TELEFONAKTIEBOLAGET L M ERICSSON (PUBL), Stockholm (SE)

(21) Appl. No.: 13/028,062

(22) Filed: Feb. 15, 2011

Related U.S. Application Data
(60) Provisional application No. 61/304,707, filed on Feb. 15, 2010.

(51) Int. Cl. H04W 4/12

(52) U.S. Cl. 455/466

(57) ABSTRACT

A system for providing machine-to-machine (M2M) messaging in a 3GPP environment makes use of the existing cell broadcast service, optionally with extensions, to allow for M2M enabled devices to be set in groups and sent messages in an efficient manner that can reduce traffic, and provide for less battery drain.

### CROSS REFERENCE TO RELATED APPLICATIONS

This application claims the benefit of priority to U.S. Provisional Patent Application No. 61/304,707 entitled “M2M GROUP BASED ADDRESSING USING CELL BROADCAST SERVICE” filed on Feb. 15, 2010, the entirety of which is enclosed herein by reference.

### TECHNICAL FIELD

This disclosure relates generally to Cell Broadcast Service and its applicability to Machine-to-Machine communications.

### BACKGROUND

At present, there is no provision for “Group based addressing” for machine-to-machine (M2M) devices in 3GPP standards. As a result, there is no general mechanism that allows for a broadcast to be addressed to a defined group of devices for M2M application purposes. Although a Cell Broadcast Service (CBS), as disclosed in TS 23.041 exists, is not oriented towards M2M purposes and does not address many of the needs for M2M communications.

In general the existing CBS is used to display broadcast Text information for human end user consumption via the MMI. Because it is intended for interactions with human end users, CBS does not consider issues relevant to M2M needs, including the effect of these services on battery consumption. Existing CBS implementations increase battery consumption as the broadcast intervals are geared towards human end users and to mobile users that may be traveling quickly through a cell. The existing CBS implementations do not consider the behavior requirements of M2M that may be stationary (e.g. smart utility meters that rarely communicate and when they do may not be doing so in a time sensitive manner). Such M2M systems often have different battery concerns as they be deployed in hostile environments requiring extended battery support.

Current solutions do not define a standardized method to define a M2M group. Operators in 3GPP M2M related activities have expressed the need for such a mechanism for the 3GPP system but none is yet defined. Stage 1 Service requirements in the area have been documented in ongoing SA1 Technical Spec TS 22.368 standardization activities related to M2M communications. Group Based Addressing MTC (Machine Type Communication) Feature in TS 22.368 v1.1.1 states: “ . . . For the Group Based Addressing MTC Feature: It shall be possible to send a broadcast message to a large group of MTC Devices affiliated with a single MTC Subscriber.” but no indication of how this is to be performed is provided.

Stage 2 publications for the group based addressing 3GPP TR 23.888 has not identified a solution. Nor have they identified the method by which the Cell Broadcast Service could be exploited to solve the “Group addressing” feature.

Those skilled in the art will appreciate that related information can be found in the following publicly available standards related documents, each of which is expressly incorporated by reference herein:
3GPP TS 22.003 v9.0.0 Circuit Switch Services supported by a Public Land Mobile Network (PLMN)
3GPP TS 23.041 v9.2.0 Technical realization of Cell Broadcast Service (CBS)
3GPP TS 25.324 v9.0.0 Broadcast/Multicast Control (BMC)
3GPP TS 22.368 Service Requirements for Machine-Type Communications
3GPP TR 23.888 System Improvements for Machine-Type Communications
3GPP TS 23.060 GPRS Service Description
3GPP TS 23.401 GPRS Enhancements for E-UTRAN

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of sending a message to a plurality of Machine-to-Machine devices connected to a radio access network. The method comprises the steps of identifying a group of devices that the message should be sent to; indicating the identified group in a cell broadcast service message; and transmitting the cell broadcast service message to the indicated group.

In an embodiment of the first aspect of the present invention, the step of indicating includes encoding the identified group in the cell broadcast message. Optionally, the identified group is encoded in the cell broadcast message by storing a group identifier in a “Message Identifier” field of the message. In another embodiment, the method further includes the step of including schedule information in the cell broadcast service message before the step of transmitting the message. Optionally, the schedule information identifies an anticipated next cell broadcast service message delivery window. In a further embodiment, the step of transmitting includes broadcasting the message to all nodes connected to the radio access network.

In a second aspect of the present invention, there is provided a method of processing a cell broadcast service message in a terminal device. The method comprises receiving the cell broadcast service message over a radio access network interface, the message identifying a group; and processing the received cell broadcast service message if the group identified in the message corresponds to a group associated with the terminal device.

In an embodiment of the second embodiment, the step of receiving includes receiving the cell broadcast service message; and checking the received message for an encoded group identifier. Optionally, the step of checking includes checking a “Message Identifier” field in the received message. In another embodiment, the step of processing includes determining that the group identified in the received message does not correspond to a group associated with the terminal device and ignoring the message. In another embodiment, the step of processing includes retrieving a list of groups associated with the terminal device from a memory preconfigured to identify the groups associated with the terminal device. Optionally, the method further includes the step of comparing the group identified in the message with the groups in the retrieved list. In a further embodiment, the step of processing includes determining if the received message includes scheduling information. Optionally, the step of performing standard processing on the received message upon determination that the received message does not include scheduling information. This embodiment can also further include the step of determining a next anticipated cell broadcast service message window in accordance with scheduling information included in the received message, and optionally the step of ignoring all incoming cell broadcast service messages until the determined next window.

In the third aspect of the present invention, there is provided a node for transmission of cell broadcast service messages through a radio access network. The node comprises a memory, a network interface and a processor. The memory stores group identifiers. The network interface transmits messages through a radio access network. The processor composes a cell broadcast message in accordance with received cell broadcast service message content, retrieves a group identifier to allow addressing the cell broadcast service message to a group associated with the identifier, and transmits the cell broadcast service message to the group through the network interface.

In an embodiment of the third aspect, the processor addresses the cell broadcast service message to the group by encoding the group identifier in the cell broadcast message. Optionally, the processor encodes the group identifier in a “Message Identifier” field. In another embodiment there is further included a scheduler for determining the next anticipated cell broadcast service message delivery window associated with the group associated with the identifier and for providing scheduling information associated with the determined window to the processor for inclusion in the cell broadcast service message.

In a fourth aspect of the present invention, there is provided a node for processing a cell broadcast service message. The node comprises a network interface, a memory and a processor. The network interface receives the cell broadcast service message. The memory stores a preconfigured group identifier associated with the node. The processor determines that the received message is addressed to a group, and processes the message upon determining that the addressed group corresponds to the preconfigured group identifier.

In an embodiment of the fourth aspect of the present invention, the memory is embedded on a subscriber identity module. In another embodiment, the processor determines the received message is addressed to a group by inspecting a “Message Identifier” field in the received message. In a further embodiment, the node further includes a scheduler for obtaining from the processor a next anticipated cell broadcast service message delivery window upon processing of the message, the scheduler operatively connected to the network interface to instruct the network interface when to next anticipate delivery of a cell broadcast service message in accordance with the delivery window.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention may be described, by way of example only, with reference to the Figures wherein:

FIG. 1 is a flow chart illustrating an exemplary method of the present invention;

FIG. 2 is a flow chart illustrating an exemplary method of the present invention;

FIG. 3 is a flow chart illustrating an exemplary method of the present invention;

FIG. 4 is a flow chart illustrating an exemplary method of the present invention;

FIG. 5 is a flow chart illustrating an exemplary method of the present invention;

FIG. 6 is a flow chart illustrating an exemplary method of the present invention;

FIG. 7 is a block diagram of a node for generating and transmitting CBS messages according to an exemplary embodiment of the present invention; and

FIG. 8 is a block diagram of a node for receiving and processing CBS messages according to an exemplary embodiment of the present invention.

### DETAILED DESCRIPTION

The present invention is directed to a system and method for a machine-to-machine group based addressing system using cell broadcast services.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In embodiments of the present invention, solutions to some of the deficiencies in the prior art are provided by extending the Cell Broadcast Service as a transparent bearer for M2M type broadcast communication as opposed to just a messaging service for Human end user consumption. Some of the extensions provided in embodiments discussed below may include:
Understanding that Message Identifier can be used as basic “Group Identifier”
Define/reserve a set of Cell Broadcast Message Identifiers reserved for M2M purposes
Expand necessary message definitions to support an explicit “group identifier”
Define that such a set of message are relayed to M2M application layer in the M2M device.
Define a new Cell Broadcast Service M2M message
Define a means to schedule non-M2M and M2M CBS messages using the CBS Scheduling messages
A method to efficiently assign Group IDs to M2M using the Protocol configuration option when they 1st attach to the network

The MTC Feature Group Based Addressing supported in the existing art is intended for use with a large group of MTC Devices belonging to the same MTC Subscriber, for which the network operator wants to optimize the message volume when many MTC devices need to receive the same message. In one embodiment of the present invention, the 3GPP system provides a transparent message channel towards the M2M devices and should not be concerned with the content or nature of the broadcast message. By making such a service available, a number of different functions can be enabled. A non-exhaustive list of such uses includes:
Transmission rating/pricing info to large group of vending machines
Push “time controlled” information indicating such time period/schedule or time dispersion attributes to spread out reports from M2M devices
Order M2M devices into special states such as maintenance modes
Push updates of configuration, software or firmware
Push update of “events” or thresholds that telemetry devices need to monitor and or use as trigger points for reporting of data

The Cell Broadcast Service (TS 23.041) provides a basis for defining a transparent bearer for M2M by re-using the cell broadcast as a means to efficiently address a group of M2M devices. The Cell Broadcast Service can be characterized by the following aspects:
No acknowledgement needs to be sent from the UE.
The cell broadcast message can be sent in a limited area, defined by the originator of the message, by agreement with the PLMN.
An identifier can be associated with each message. This identifier is received by the UE and used by the short message function of the UE not to store broadcast messages which may not be wanted or which have already been received.
Generally, cell broadcast messages can be sent continuously, so that all such messages are sent in turn, and then repeated. The cycle time is preferably short enough for important messages to be received by travelers moving through a group of cells.
Cell broadcast messages are preferably MT only. The origination of these messages is outside the scope of 3GPP specifications.
The maximum length of each cell broadcast message is preferably limited to 93 characters.
Cell broadcast DRX mode is preferably defined to improve the battery life for User equipment.
Reception of CBS messages for a UE is not a requirement if it is connected in the CS domain. It is preferable that a UE to can receive messages if it is connected in the PS domain and no data is currently transmitted.

Embodiments of the present invention allow the MTC server to act as a Cell Broadcast Entity (CBE) which can connect to the Cell Broadcast Center through which the MTC server can initiate broadcast of CBS messages to a group of devices. The basic existing coding of an embodiment of a CBS message of the present invention contains the following:

TABLE 1
Message Parameter

| Octet Number(s) | Field |
|---|---|
| 1-2 | Serial Number |
| 3-4 | Message Identifier |
| 5 | Data Coding Scheme |
| 6 | Page Parameter |
| 7-88 | Content of Message |

It should be noted that TS 23.041 shows flexibility in defining and usage of new “Message IDs”. This is done so that some ranges are reserved for future standardization, while other ranges are set aside as PLMN operator specific ranges (i.e. A000-AFFF, B000-EFFF).

The basic behaviour of the system of the present invention is that the M2M ME attempts to receive the CBS messages for which Message Identifiers are in the “search list” of the SIM/USIM. For example, using PLMN operator specific range Message IDs allows one to potentially to map “Group IDs” to Message IDs “ . . . As an example, Group ID 0 can be defined as Message ID A000, while Group ID 1 can be defined as Message ID A001, etc.

In such a configuration, an M2M device can be assigned to Groups and would be programmed with the Message IDs associated to the Groups IDs it belongs. This configuration could be stored on the subscriber identity module (SIM) or equivalent element. This approach permits UEs to belong to multiple groups by listening for multiple Message IDs. The existing “Content of Message” parameter can carry the M2M “application message” that MTC Server intends to broadcast to the Group (via CBC). The Data Coding scheme permits a text and binary encoding.

When communicating with the CBC the repetition period and the number of broadcasts are indicated by the CBE. In the context of M2M the information may not be as dynamic as for other applications (e.g. text based dynamic traffic reports or advertisements aimed toward human end users). As well for M2M devices that are stationary (e.g. utility meters) the repetition rate can be low as compared to attempting to broadcast messages to mobile devices traveling at high velocity through the cell. CBS offers flexibility for up to 15 pages to be concatenated to form a CBS message.

As opposed to a typical text based CBS message that is presented to human user via the user equipment interface, the present invention allows the M2M UE devices to have the ability to inform a higher level M2M application layer of received M2M messages for suitable processing. Extensions that are envisioned that would benefit M2M broadcast services can include
Reserving a distinct set of message Identifiers for explicit M2M application purposes. This will aid in interoperability between M2M application and device manufactures. It facilitates operation in the UE in determining whether the message should be delivered to a higher level M2M application layer in the UE.
Extending the message definitions (including messages between CBE-CBC and over air transmission) to include an explicit Group Identifier. Without this the existing functionality may lack the ability to explicitly address a group. A mapping function may be required, preferably performed by the MTC User (i.e. Utility company). This will also preferably require coordination between different MTC Users to ensure that that they do use same Message Identifiers as M2M devices belonging to different groups so that such devices are not needlessly listening to the same message. The M2M application in the device preferably possesses the logic to discard the M2M application message, perhaps by examining proprietary IE in the application message. This approach can unnecessarily consume battery of M2M device.

Among many advantages that can be provided by different embodiments of the present invention, existing base functionality with (using a Group ID to message ID mapping) allows for implementation without impacting a large number of standards changes for M2M device support. Additionally, CBS enables broadcasts to a large UE population in an efficient manner Current CBS message definition permits its usage as a bearer for M2M Group messages. Message Id can serve as, or be mapped to, a M2M application level “Group ID”. This can be expanded by introducing an explicit “group Id” in the message definitions. Flexibility between CBE and CBC allows for broadcasts that permit the MTC server to define geographic areas over which messages are to be broadcast as well as for the scheduling of the message. Flexible message length through use of concatenated CBS messages can be supported. The CBS can schedule message for broadcast in CBS DRX mode for mobile stations. A Schedule message is helpful in minimizing battery usage for Cell Broadcast in the Mobile Station, because it allows the MS to ignore transmissions of CBS messages the customer is not interested in.

3GPP TS 25.324 describes a standard Broadcast/Multicast Control. It contains definition of 2 key messages BMC CBS message, BMC Schedule Message. Based on the definition of BMC CBS Message the following new “BMC CBS M2M Message” can be defined which introduces a “M2M Group ID”. The CBS Message can carry the cell broadcast data and the address information if the address information is based on GSM CBS.

TABLE 2
New CBS M2M Message definition

| | | | Type and | |
|---|---|---|---|---|
| Information Element | Need | Multi | reference | Semantics description |
| Message Type | MP | | Sec. 11.1 | |
| Message ID | MP | | Sec. 11.2 | |
| Serial Number | MP | | Sec. 11.3 | |
| Data Coding Scheme | MP | | Sec. 11.4 | |
| CB Data | MP | | Sec. 11.5 | |
| M2M Group ID | MP | | | *** New IE defining |
| | | | | a M2M Group ID |

One skilled in the art will appreciate that a group id definition can allow for globally unique identifiers. For example a group id can be prefixed/built/constructed with unique mobile country codes and mobile network codes as per existing IMSI definition (e.g. MCC+MNC+group ID).

The creation of new “M2M CBS message” may also require a new Message Type value.

TABLE 3
Message Type IE

| | | | Type and | |
|---|---|---|---|---|
| IE/Group name | Need | Multi | reference | Semantics description |
| Message Type | MP | | Enumerated | This IE is coded as the |
| | | | (0. . . 255) | binary representation of the |
| | | | Table 11.1-2 | Message Type. This IE is |
| | | | | mapped onto a single |
| | | | | octet. |

TABLE 4
Coding of Message Type IE

| | |
|---|---|
| 1 | CBS Message |
| 2 | Schedule Message |
| 3 | CBS41 Message |
| 4 | M2M CBS Message ( . . . new message type |
| | only read by M2M devices |
| 0, 5. 255 | Reserved for future use (PDUs with this coding |
| | will be discarded by this version of the protocol) |

In each CBS schedule period, a BMC Schedule Message specifies both the time slot locations for each CBS message, and the time at which the next Schedule Message (for the next CBS schedule period) will be sent. To inform devices in a specific M2M group of succeeding CBS M2M messages, an optimization of the standard method provides the ability to indicate when a CBS M2M Message is to be broadcast. In one embodiment, this is achieved by updating the “message description” to be able to carry the M2M Group ID. This preferably indicates whether the associated Message ID is associated to a CBS M2M message (or regular CBS message) as well as indicating to which specific M2M Group ID the message is applicable.

TABLE 5
Message Description IE updated to include new [symbol] M2M Group ID [symbol] concept

| IE/Group Name | Need | Multi | Type and reference | Semantics description |
|---|---|---|---|---|
| Message | MP | | Enumerated(0 . . . 255) | This IE is coded as the |
| Description Type | | | Table 11.9-3 | binary representation of |
| | | | | the Message Description |
| | | | | Type. This IE is mapped |
| | | | | onto a single octet. |
| Message ID | CV MDT1 | | Octet string (2) | This IE is coded as the |
| | | | | binary representation of |
| | | | | the Message ID. The first |
| | | | | octet contains octet 1 of |
| | | | | the equivalent IE defined |
| | | | | in and encoded according |
| | | | | to [3] and so on. |
| M2M GROUP ID | MP | | Octet string (2) | This IE is coded as the |
| | | | | binary representation of |
| | | | | the GROUP ID. |
| | | | | =0 indicates that |
| | | | | message ID is for a |
| | | | | “normal” user (i.e. NOT |
| | | | | an M2M Group |
| | | | | broadcast) |
| | | | | >0 indicates the M2M |
| | | | | Group to which the |
| | | | | Message ID is applicable |
| Offset to CTCH | CV MDT2 | | Integer (0 . . . 255) | This IE is coded as the |
| BS index of first | | | | binary representation of |
| transmission | | | | the Offset to CTCH BS |
| | | | | index of first transmission |
| | | | | relative to the start of the |
| | | | | BMC schedule period. This |
| | | | | IE is mapped onto a single |
| | | | | octet. |

M2M devices preferably maintain a search list of Group IDs representing the Group(s) to which they belong. The Group IDs can be provisioned in the device in a number ways including: Over the Air Activation and/or assigned as part of “PCO” (Protocol Capability Options“) when first attaching to the 3 GPP system, as well as other standard mechanisms that will be understood by someone skilled in the art.

An M2M device can report a received CBS M2M message to a higher level M2M application level upon reception of a message addressed to the Group ID to which the mobiles belong (i.e. In mobile Group ID search list).

A system and method of the present invention provide for a number of different advantages that will be apparent to those skilled in the art. Advantages that may be provided by some embodiments (not all embodiments of the present invention will provide all or even any of the following advantages) include:
The ability to explicit identify CBS messages that should only be read by a M2M device that is part of a specific Group through a new CBS M2M message
The ability to explicitly indicate in the CBS Schedule message information regarding subsequent CBS M2M messages allowing M2M devices to preserve battery life by not listening for messages until the indicated time. M2M devices will only read CBS messages broadcast specifically to their Group ID
The ability to simultaneously and independently schedule normal (non M2M group) broadcast (for H2H consumption via MMI in the UE) and broadcast messages directed to Specific M2M Groups
Inclusion of the Group ID may allow for efficient broadcasting of a message to a defined set of M2M devices. As the CBS M2M message is addressed to a Group Id and not to an individual M2M device identifier an unlimited number of devices can receive message at one time
permits sharing of the limited FACH (Forward Access Channel) of the broadcast service by allowing selective scheduling of M2M and Non-M2M broadcast messages
Ability to provisioning “M2M Group IDs” using the Protocol Configuration Option at attach of the M2M device to the network. Simplifies deployment easing mass deployment of M2M devices

As discussed above, a mechanism can be provided to encode a group identifier into a standard CBS message, and then broadcast the message. Properly configured user equipment will then be able to identify which messages are relevant by only listening to the messages associated with their groups. In an M2M environment it may be important for terminal devices to enter power saving states instead of constantly listening for broadcast messages. To facilitate this, the M2M CBS messages can include scheduling information that will provide the terminal device with an indication of a time window in which the next message will be received. This will allow the device to remain in a power saving state between possible windows.

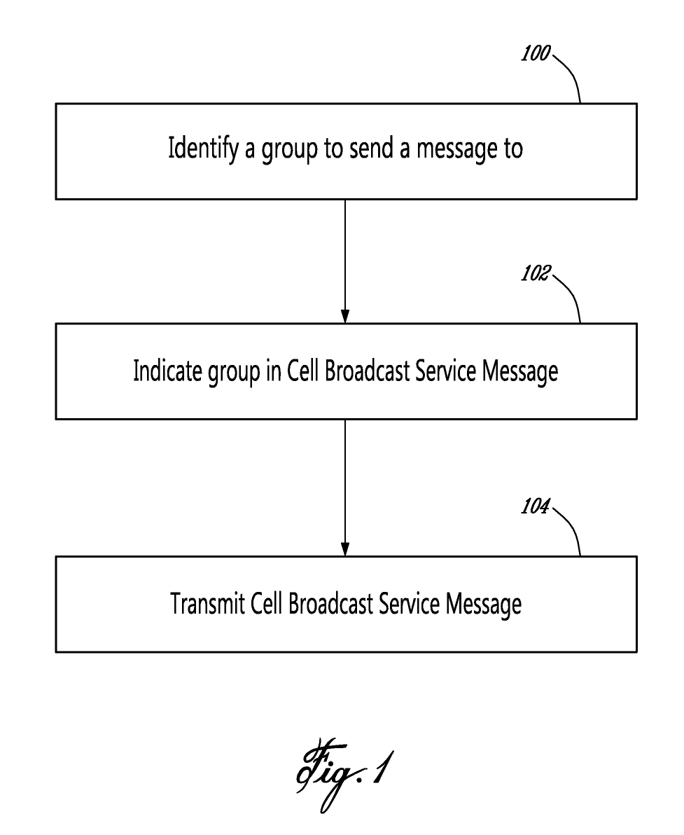

FIG. 1 illustrates an exemplary method of sending such a M2M CBS message. In step 100 a group of devices is identified as the intended recipient of the message. In step 102 the identified group is indicated in the CBS message, and then the message is transmitted using the Cell Broadcast service.

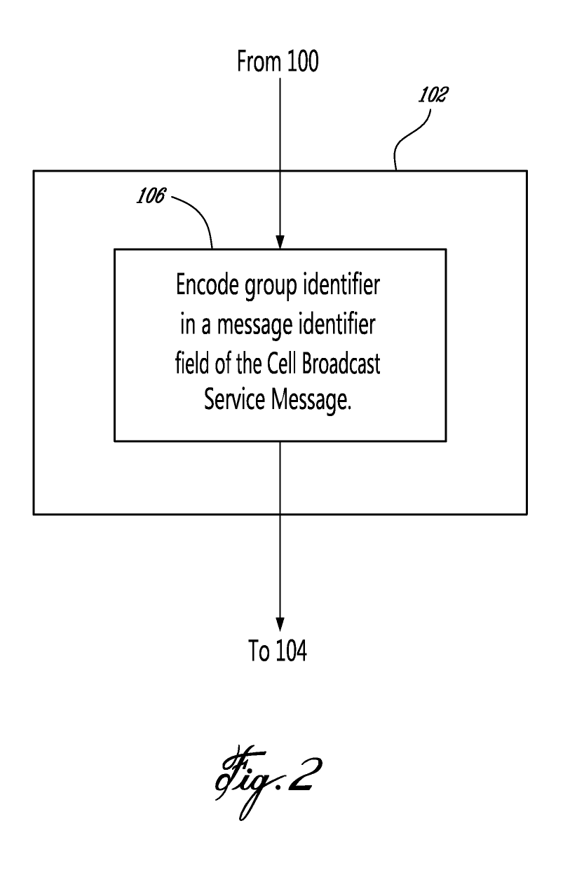

FIG. 2 illustrates an embodiment of the method of FIG. 1, where step 102 is performed so that it includes the step 106 of encoding a group identifier associated with the group to be indicated in a Message Identifier field of the Cell Broadcast Service Message.

FIG. 3 illustrates an embodiment of the method of FIG. 1 which includes optional step 108 between steps 102 and 104. In step 108 schedule information relevant to the indicated group is included in the cell broadcast message prior to transmission.

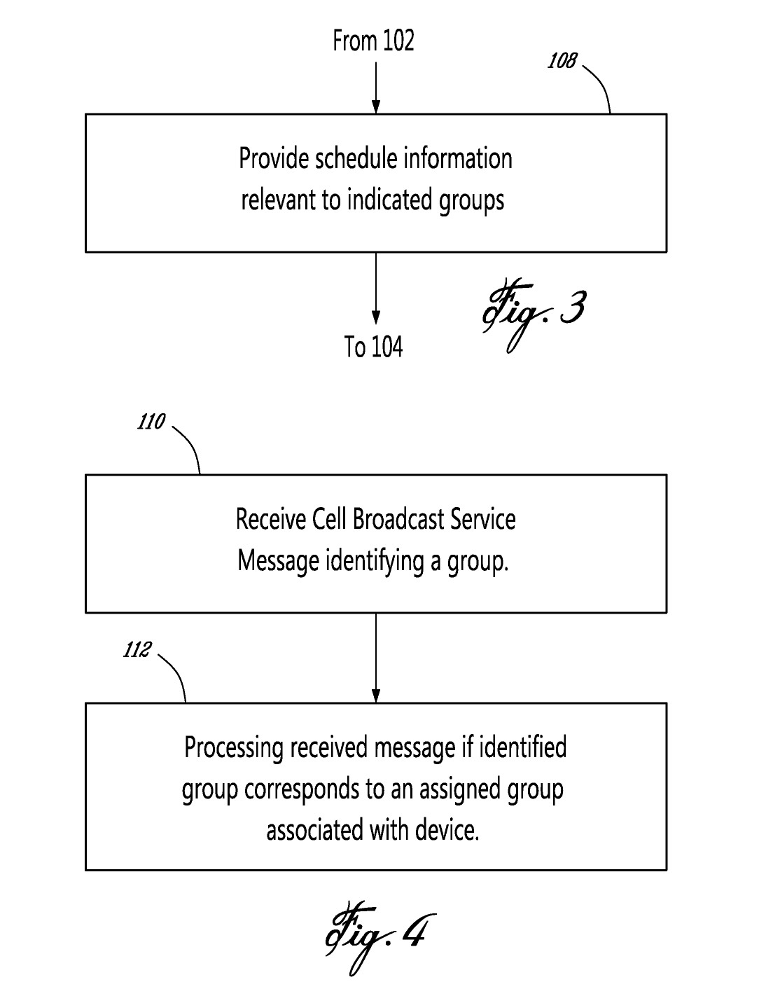

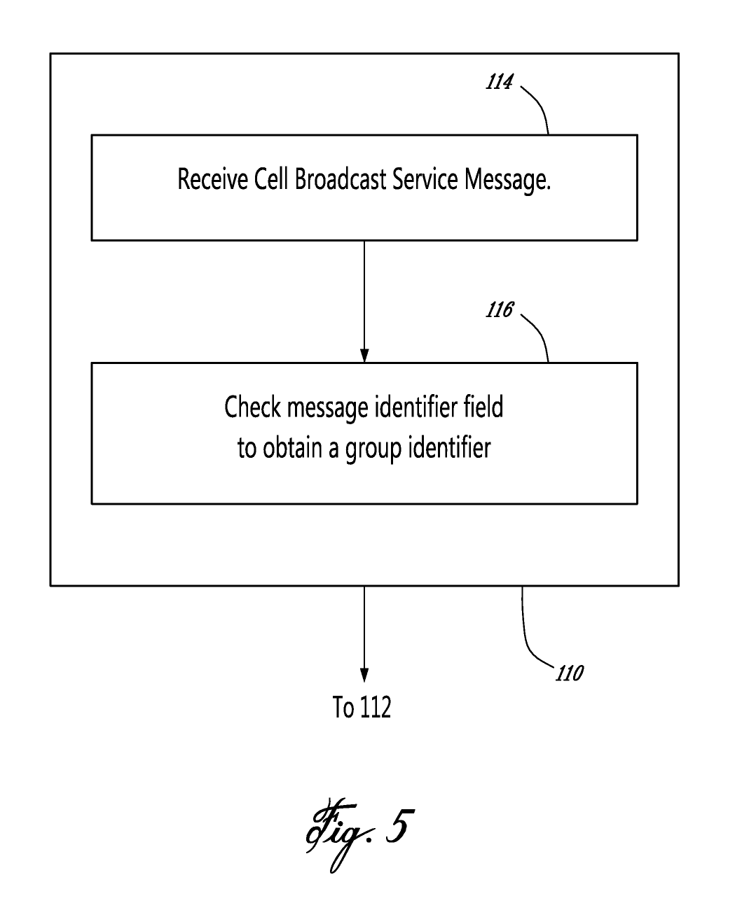

FIG. 4 illustrates an exemplary method of processing a received Cell Broadcast message. In step 110 the terminal device receives a Cell Broadcast Service message that identifies a group. In step 112, the received message is processed if the group identified in the message matches a group associated with the device. As noted above, a device can be configured to belong to a group through configuration information stored in a memory such as on the subscriber identity module (SIM) or other such element such as USIM or microSIM.

FIG. 5 illustrates an embodiment of the method discussed in FIG. 4, where step 110 includes steps 114 and 116. In step 114, the terminal device receives the cell broadcast service message, and then in step 116 the Message Identifier field of the received message is checked to obtain the group identifier associated with the message.

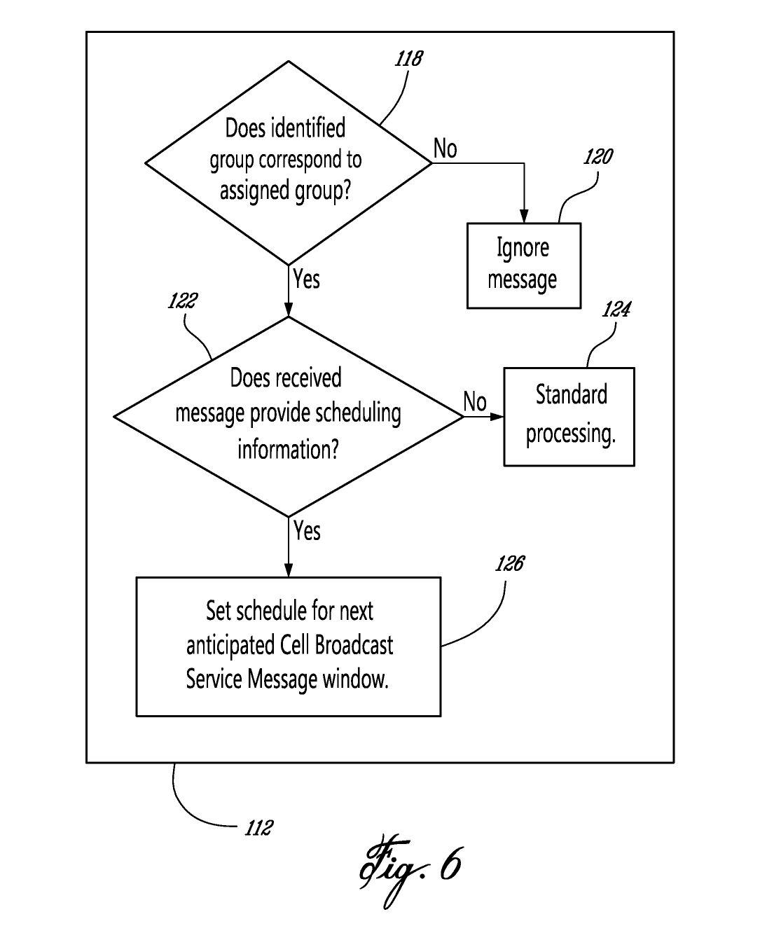

In FIG. 6, an exemplary method of carrying out step 112 of FIG. 4 is provided. Following step 110, in step 118, a determination is made as to whether or not the group identified by the received message corresponds to the group assigned to the terminal device. If the groups do not correspond, the message is ignored in step 120. If there is a correspondence, the message is checked for scheduling information in step 112. If no scheduling information is found, standard processing of the message is undertaken in step 124. If scheduling information is found, the schedule for the next anticipated CBS message window is set in step 126. One skilled in the art will appreciate that a terminal device can have multiple groups, and thus can be provided with multiple schedules. A terminal device that is outside of an anticipated CBS message window can optionally reduce power consumption by no longer listening for CBS messages.

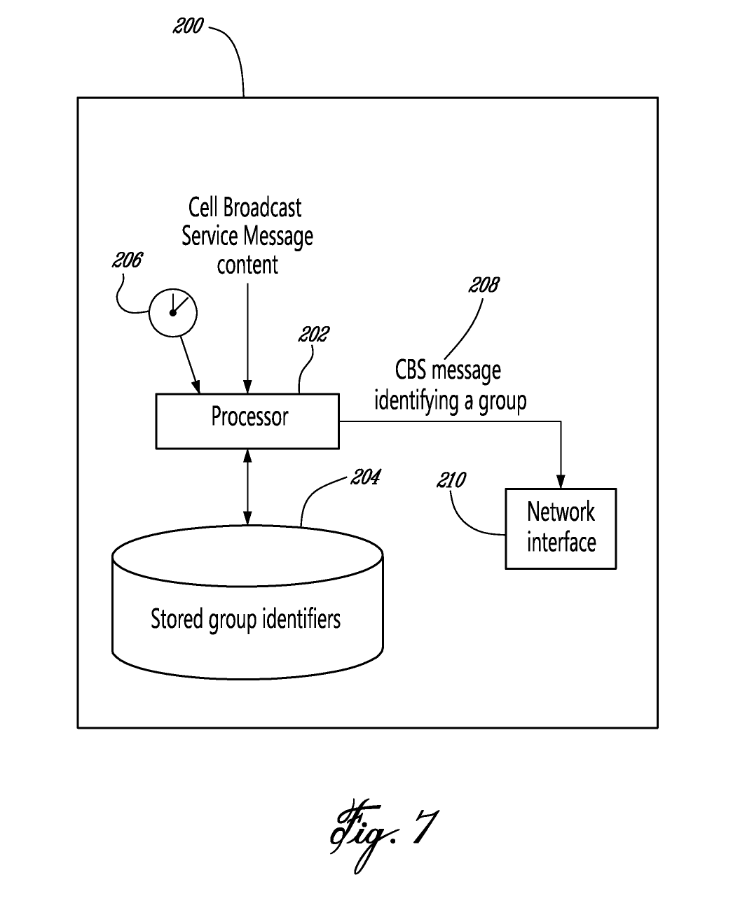

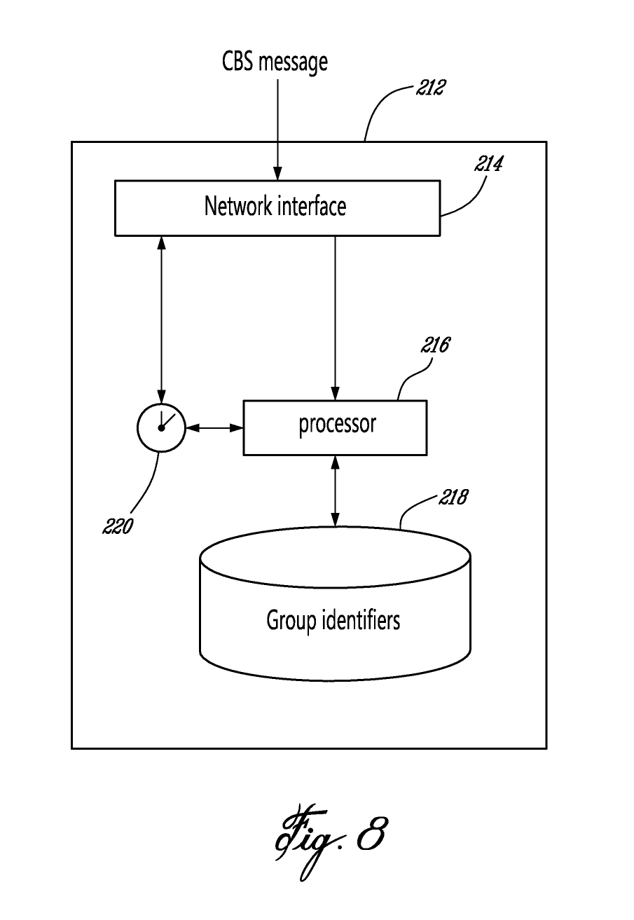

FIG. 7 illustrates an exemplary block diagram of a node 200 for generating and transmitting CBS messages in accordance with the methods discussed above. The node 200 includes a processor 202 which receives CBS message content, and retrieves stored group identifiers from memory 204. This information is used, optionally with information provided by scheduler 206, to create a CBS message 208 that identifies a recipient group. Message 208 is provided to network interface 210 for delivery to nodes connected over a radio access network.

FIG. 8 illustrates an exemplary block diagram of a node 212 for receiving CBS messages addressed to a group. A CBS message is received by network interface 214 and is provided to processor 216. Processor 216 examines the received message to identify an addressed group, and compares the addressed group to a group identifier retrieved from memory 218. One skilled in the art will appreciate that memory 218 may be embodied in a subscriber identity module. The message is processed by processor 216 if the identified group and the preconfigured group match, and can otherwise be ignored. Node 212 may also include a scheduler 220 that obtains scheduling information included in the received message from processor 216. If a schedule for a next anticipated cell broadcast service message delivery window is included in the message, the scheduler can allow the network interface 214 to be put in a power saving state and then re-activate the network interface 214 to receive the next scheduled message. This allows for power savings in devices that can benefit from such a service.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of sending a message to a plurality of Machine-to-Machine devices connected to a radio access network, the method comprising:
identifying a group of devices that the message should be sent to;
indicating the identified group in a cell broadcast service message; and
transmitting the cell broadcast service message to the indicated group.

2. The method of claim 1 wherein the step of indicating includes encoding the identified group in the cell broadcast message.

3. The method of claim 2 wherein the identified group is encoded in the cell broadcast message by storing a group identifier in a “Message Identifier” field of the message.

4. The method of claim 1 further including the step of including schedule information in the cell broadcast service message before the step of transmitting the message.

5. The method of claim 4 wherein the schedule information identifies an anticipated next cell broadcast service message delivery window.

6. The method of claim 1 wherein the step of transmitting includes broadcasting the message to all nodes connected to the radio access network.

7. A method of processing a cell broadcast service message in a terminal device, the method comprising:
receiving the cell broadcast service message over a radio access network interface, the message identifying a group; and
processing the received cell broadcast service message if the group identified in the message corresponds to a group associated with the terminal device.

8. The method of claim 7 wherein the step of receiving includes:
receiving the cell broadcast service message; and
checking the received message for an encoded group identifier.

9. The method of claim 8 wherein the step of checking includes checking a “Message Identifier” field in the received message.

10. The method of claim 7 wherein the step of processing includes determining that the group identified in the received message does not correspond to a group associated with the terminal device and ignoring the message.

11. The method of claim 7 wherein the step of processing includes retrieving a list of groups associated with the terminal device from a memory preconfigured to identify the groups associated with the terminal device.

12. The method of claim 11 further including the step of comparing the group identified in the message with the groups in the retrieved list.

13. The method of claim 7 wherein the step of processing includes determining if the received message includes scheduling information.

14. The method of claim 13 further including the step of performing standard processing on the received message upon determination that the received message does not include scheduling information.

15. The method of claim 13 further including the step of determining a next anticipated cell broadcast service message window in accordance with scheduling information included in the received message.

16. The method of claim 15 further including the step of ignoring all incoming cell broadcast service messages until the determined next window.

17. A node for transmission of cell broadcast service messages through a radio access network, the node comprising:
a memory for storing group identifiers;
a network interface for transmitting messages through a radio access network; and
a processor for composing a cell broadcast message in accordance with received cell broadcast service message content, for retrieving a group identifier to allow addressing the cell broadcast service message to a group associated with the identifier, and for transmitting the cell broadcast service message to the group through the network interface.

18. The node of claim 17 wherein the processor further addresses the cell broadcast service message to the group by encoding the group identifier in the cell broadcast message.

19. The node of claim 18 wherein the processor encodes the group identifier in a “Message Identifier” field.

20. The node of claim 17 further including a scheduler for determining the next anticipated cell broadcast service message delivery window associated with the group associated with the identifier and for providing scheduling information associated with the determined window to the processor for inclusion in the cell broadcast service message.

21. A node for processing a cell broadcast service message, the node comprising:
a network interface for receiving the cell broadcast service message;
a memory for storing a preconfigured group identifier associated with the node; and
a processor for determining that the received message is addressed to a group, and for processing the message upon determining that the addressed group corresponds to the preconfigured group identifier.

22. The node of claim 21 wherein the memory is embedded on a subscriber identity module.

23. The node of claim 21 wherein the processor determines the received message is addressed to a group by inspecting a “Message Identifier” field in the received message.

24. The node of claim 21 further including a scheduler for obtaining from the processor a next anticipated cell broadcast service message delivery window upon processing of the message, the scheduler operatively connected to the network interface to instruct the network interface when to next anticipate delivery of a cell broadcast service message in accordance with the delivery window.
